(19) United States
(12) Patent Application Publication
(10) Pub. No.: US 2019/0372998 A1
(43) Pub. Date: Dec. 5, 2019

(54) EXCHANGE-TYPE ATTACK SIMULATION DEVICE, EXCHANGE-TYPE ATTACK SIMULATION METHOD, AND COMPUTER READABLE MEDIUM

(71) Applicant: MITSUBISHI ELECTRIC CORPORATION, Tokyo (JP)

(72) Inventors: Hiroki NISHIKAWA, Tokyo (JP); Takumi YAMAMOTO, Tokyo (JP); Keisuke KITO, Tokyo (JP); Kiyoto KAWAUCHI, Tokyo (JP)

(73) Assignee: MITSUBISHI ELECTRIC CORPORATION, Tokyo (JP)

(21) Appl. No.: 16/478,546

(22) PCT Filed: Feb. 14, 2017
(86) PCT No.: PCT/JP2017/005365

§ 371 Date: Jul. 17, 2019

(51) Int. Cl. H04L 29/06

(52) U.S. Cl. CPC H04L 63/1408; H04L 63/1441

(57) ABSTRACT

In an exchange-type attack simulation device (10), an e-mail reception unit (22) receives a reply e-mail to an e-mail transmitted by an e-mail transmission unit (26). A state transition unit (24) refers to correspondence information (31) indicating feature of e-mails corresponding to each of state transitions in a state transition model and thereby identifies a state transition corresponding to the reply e-mail received by the e-mail reception unit (22). An e-mail generation unit (25) generates an e-mail corresponding to the state transition identified by the state transition unit (24). The e-mail generation unit (25) makes the e-mail transmission unit (26) transmit the generated e-mail.

### TECHNICAL FIELD

The present invention relates to an exchange-type attack simulation device, an exchange-type attack simulation method, and an exchange-type attack simulation program.

### BACKGROUND ART

Targeted attack in which such attacks as theft of confidential information are made with specific organizations or persons set up as targets has become a serious threat. Above all, attack based on e-mails with use of targeted e-mails remains one of grave threats.

One of means to prevent the attack with the targeted e-mails is a training system or service against the targeted e-mails. In the system or service, it is supposed that trainees are trained through actual transmission to the trainees of such simulated targeted e-mails as may be actually sent. By such means, the trainees may be trained to comprehend what the actual targeted e-mails are like and what actions are to be taken upon reception of the targeted e-mails.

Patent Literature 1 discloses a system of providing training against the targeted e-mails. In this system, a dummy mail simulating a targeted e-mail is produced with use of a template prepared in advance and is distributed to object users. A text of the produced dummy mail is composed so as to include wording that may make the trainees feel strange.

Recently, attacks with targeted e-mails have been made in which such an e-mail as to cause infection with malware is transmitted after trust is gained through several exchanges with a target. Such attacks are referred to as exchange-type attacks.

The exchange-type attacks have not been much reported. Due to sophistication of the attacks, however, there is a high possibility that some of the attacks have not been noticed and there is a possibility that the exchange-type attacks more than reported have existed actually.

As in Non-Patent Literature 1, a technique of generating a tweet for spear phishing by automatically generating a text is disclosed. With increase in capacity of attackers, a risk that sophisticated attacks such as the exchange-type attacks may be easily made has been rising.

### CITATION LIST

### Patent Literature

Patent Literature 1: JP 2013-149063

### Non-Patent Literature

Non-Patent Literature 1: John Seymour, Philip Tully, “Weaponizing Data Science for Social Engineering: Automated E2E Spear Phishing on Twitter”, BlackHat USA 2016, 2016

Non-Patent Literature 2: Information-technology Promotion Agency, Japan “For Customer/Support Service Representatives: Security Alert for ‘Exchange-type’ Attacks˜Reconfirmed Attacks at Five Organizations in Japan˜”, [online], Nov. 21, 2014, [Searched for on February 6, 2017], The Internet <URL: https://vvww.ipa.go.jp/security/topics/alert20141121.html>

### SUMMARY OF INVENTION

### Technical Problem

In the system of Patent Literature 1, in which exchange of e-mails cannot be carried out, training against the exchange-type attacks cannot be provided. In addition, the text to be used in the dummy mail needs to be prepared as the template in advance and thus a text adapted to circumstances cannot be automatically generated.

Even when a training against the exchange-type attacks that are sophisticated attacks may be provided, mastery of the targeted attacks and advanced technology are required for generation of e-mails of the exchange-type. While advanced technical experts are small in number, persons to be trained are large in number. Therefore, a technique of automatically providing such a training is required.

The present invention aims at automatically providing a simulation of the exchange-type attack.

### Solution to Problem

An exchange-type attack simulation device according to an aspect of the present invention, wherein the exchange-type attack simulation device simulates an attack that is launched through exchange of e-mails, with use of a state transition model, the exchange-type attack simulation device includes:
an e-mail transmission unit to transmit an e-mail;
an e-mail reception unit to receive a reply e-mail to the e-mail transmitted by the e-mail transmission unit;
a state transition unit to refer to correspondence information, stored in a memory, indicating feature of e-mails corresponding to each of state transitions in the state transition model and to identify a state transition corresponding to the reply e-mail received by the e-mail reception unit; and
an e-mail generation unit to generate an e-mail corresponding to the state transition identified by the state transition unit and to make the e-mail transmission unit transmit the generated e-mail.

### Advantageous Effects of Invention

According to the present invention, trainees may be made to experience the threat of the exchange-type attack and may be educated, through automatic provision of a simulation of the exchange-type attack.

### BRIEF DESCRIPTION OF DRAWINGS

FIG. 1 is a state transition diagram illustrating an exchange-type attack.

FIG. 2 is a block diagram illustrating a configuration of an exchange-type attack simulation device in accordance with Embodiment 1.

FIG. 3 is a block diagram illustrating a configuration of an e-mail learning unit of the exchange-type attack simulation device in accordance with Embodiment 1.

FIG. 4 is a flowchart illustrating operation of the exchange-type attack simulation device in accordance with Embodiment 1.

FIG. 5 is a flowchart illustrating a registration phase in accordance with Embodiment 1.

FIG. 6 is a table illustrating an example of attribute information in accordance with Embodiment 1.

FIG. 7 is a flowchart illustrating a learning phase in accordance with Embodiment 1.

FIG. 8 is a diagram illustrating an example of an e-mail sorting process in accordance with Embodiment 1.

FIG. 9 is a diagram illustrating an example of a process of calculating a feature vector from an e-mail, in accordance with Embodiment 1.

FIG. 10 is a diagram illustrating an example of a pre-processing for learning of a text, in accordance with Embodiment 1.

FIG. 11 is a diagram illustrating an example of a process of generating an e-mail generation model, in accordance with Embodiment 1.

FIG. 12 is a flowchart illustrating a training phase in accordance with Embodiment 1.

FIG. 13 is a flowchart illustrating a state transition process in accordance with Embodiment 1.

FIG. 14 is a diagram illustrating an example of a process of determining a state transition, in accordance with Embodiment 1.

FIG. 15 is a block diagram illustrating a configuration of the exchange-type attack simulation device in accordance with Embodiment 2.

FIG. 16 is a flowchart illustrating a registration phase in accordance with Embodiment 2.

FIG. 17 is a diagram illustrating an example of a template of excuse in accordance with Embodiment 2.

FIG. 18 is a block diagram illustrating a configuration of the exchange-type attack simulation device in accordance with Embodiment 3.

FIG. 19 is a flowchart illustrating a registration phase in accordance with Embodiment 3.

FIG. 20 is a block diagram illustrating a configuration of the exchange-type attack simulation device in accordance with Embodiment 4.

### DESCRIPTION OF EMBODIMENTS

What the exchange-type attack is like will be analyzed based on information of Non-Patent Literature 2 that is material in which the exchange-type attack is described.

According to Non-Patent Literature 2, the “exchange-type” attack is one of methods of targeted cyber attack in which a virus-laden e-mail is sent subsequent to a harmless “reconnaissance” e-mail posing as an ordinary query or the like.

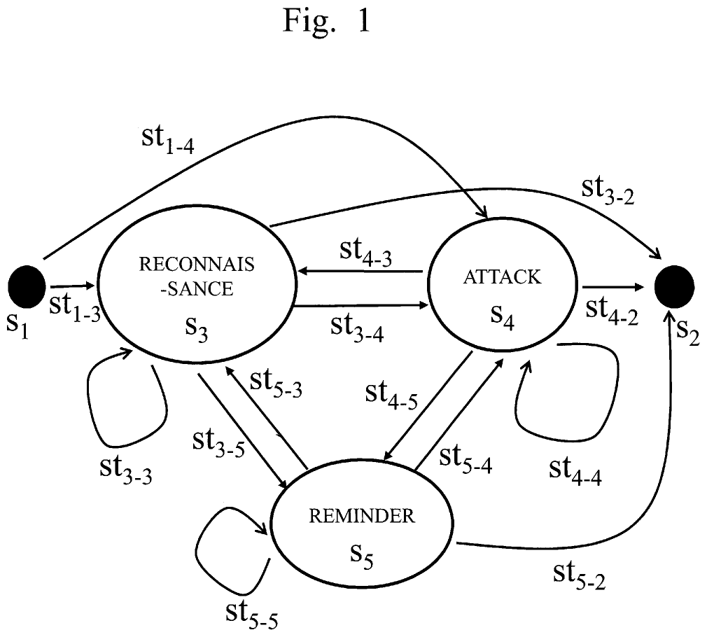

Through an analysis of the exchange-type attack based on an example disclosed in Non-Patent Literature 2, it is found that the exchange-type attack may be divided into five states of start, end, reconnaissance, attack, and reminder. A state transition model concerning the exchange-type attack based on the analysis is illustrated in FIG. 1.

Based on comparison between exchange of e-mails in the exchange-type attack and exchange of e-mails in ordinary queries, the reconnaissance may be identified with a query and the attack may be identified with file attachment or reference to a URL in a body. This identification enables using the exchange of the e-mails in the ordinary queries as learning data. The term “URL” is an abbreviation for Uniform Resource Locator.

State s1, state s2, state s3, state s4, and state s5 respectively represent the states of start, end, reconnaissance, attack, and reminder. State transitions st1-3, st3-3, and the like each represent a transition from a state to another state.

Hereinbelow, embodiments of the present invention will be described with use of the drawings. In the drawings, identical parts or corresponding parts are provided with identical characters. In description of the embodiments, description of the identical parts or the corresponding parts are omitted or simplified appropriately. Note that the present invention is not to be limited by the embodiments to be described below but may be modified in various manners as appropriate. For instance, two or more out of the embodiments to be described below may be embodied in combination. Alternatively, one of the embodiments to be described below or a combination of two or more out of the embodiments may be partially embodied.

Embodiment 1.

The present embodiment will be described with use of FIGS. 1 to 14.

*** Description of Configuration ***

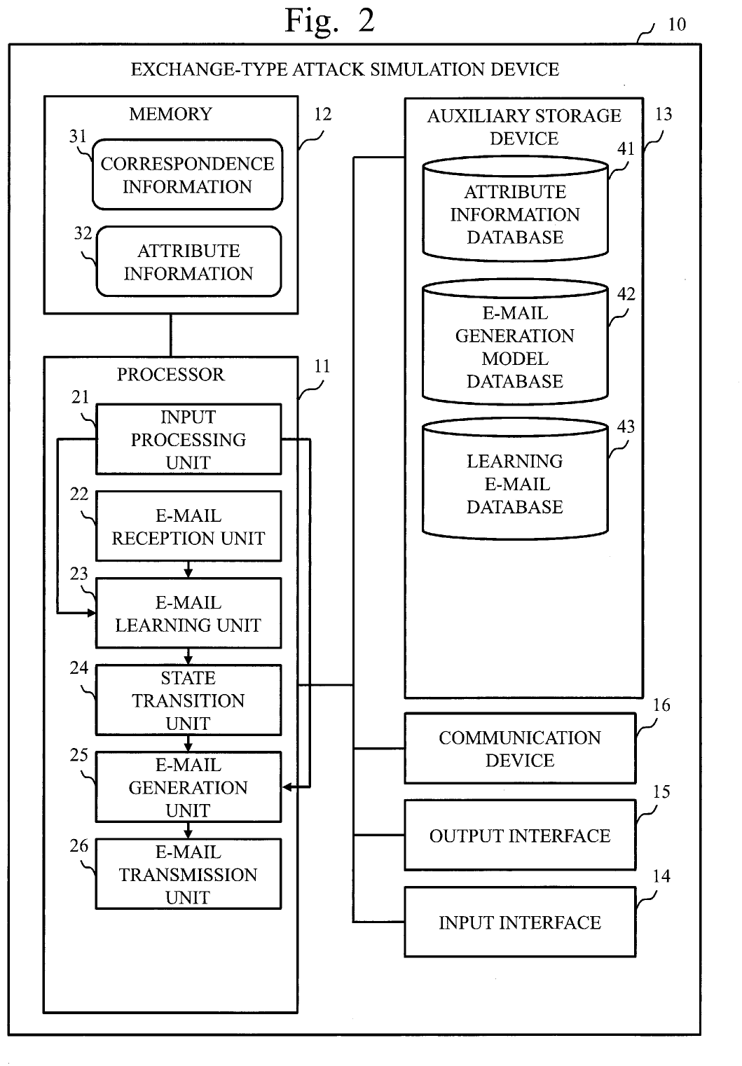

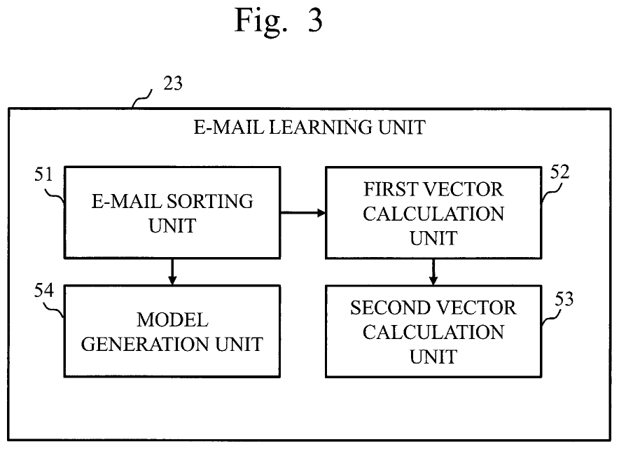

With reference to FIGS. 2 and 3, a configuration of an exchange-type attack simulation device 10 in accordance with the embodiment will be described.

The exchange-type attack simulation device 10 is a device to simulate an exchange-type attack that is launched through exchange of e-mails, with use of such a state transition model as illustrated in FIG. 1. Specifically, the exchange-type attack simulation device 10 is a device to automatically provide a simulation of the exchange-type attack by determining which of the states of reconnaissance, attack, and reminder a current state is, based on an e-mail received from a trainee. That is, the exchange-type attack simulation device 10 is a device to exchange e-mails with a trainee and to make a transition of a state in accordance with an e-mail sent from the trainee so as to automatically exchange the e-mails that may not make the trainee feel strange.

A person who provides a training is referred to as an instructor and a person who actually experiences the training is referred to as a trainee. There is no confinement to one trainee and there may be a plurality of trainees.

The exchange-type attack simulation device 10 is a computer. The exchange-type attack simulation device 10 includes a processor 11 and other hardware such as a memory 12, an auxiliary storage device 13, an input interface 14, an output interface 15, and a communication device 16. The processor 11 is connected to the other hardware through signal lines so as to control the other hardware.

The exchange-type attack simulation device 10 includes an input processing unit 21, an e-mail reception unit 22, an e-mail learning unit 23, a state transition unit 24, an e-mail generation unit 25, and an e-mail transmission unit 26, as functional components. The e-mail learning unit 23 includes an e-mail sorting unit 51, a first vector calculation unit 52, a second vector calculation unit 53, and a model generation unit 54. Functions of the input processing unit 21, the e-mail reception unit 22, the e-mail learning unit 23, the state transition unit 24, the e-mail generation unit 25, and the e-mail transmission unit 26 are implemented by software.

The processor 11 is an IC to execute various processes. The term “IC” is an abbreviation for Integrated Circuit. The processor 11 is a CPU, for instance. The term “CPU” is an abbreviation for Central Processing Unit.

Correspondence information 31 and attribute information 32 are stored in the memory 12. The memory 12 is a flash memory or a RAM, for instance. The term “RAM” is an abbreviation for Random Access Memory.

In the auxiliary storage device 13, an attribute information database 41, an e-mail generation model database 42, and a learning e-mail database 43 are located. The auxiliary storage device 13 is a flash memory or an HDD, for instance. The term “HDD” is an abbreviation for Hard Disk Drive. Databases such as the attribute information database 41, the e-mail generation model database 42, and the learning e-mail database 43 are appropriately stored in the memory 12.

The input interface 14 is an interface to be connected to an input device not illustrated. The input device is a mouse, a keyboard, or a touch panel, for instance.

The output interface 15 is an interface to be connected to a display not illustrated. The display is an LCD, for instance. The term “LCD” is an abbreviation for Liquid Crystal Display.

The communication device 16 includes a receiver to receive data such as e-mails and a transmitter to transmit data such as e-mails. The communication device 16 is a communication chip or an NIC, for instance. The term “NIC” is an abbreviation for Network Interface Card.

In the auxiliary storage device 13, an exchange-type attack simulation program that is a program to implement the functions of the input processing unit 21, the e-mail reception unit 22, the e-mail learning unit 23, the state transition unit 24, the e-mail generation unit 25, and the e-mail transmission unit 26 is stored. The exchange-type attack simulation program is loaded into the memory 12 and is then executed by the processor 11. An OS is also stored in the auxiliary storage device 13. The term “OS” is an abbreviation for Operating System. The processor 11 executes the exchange-type attack simulation program while executing the OS. A portion or all of the exchange-type attack simulation program may be integrated into the OS.

The exchange-type attack simulation device 10 may include a plurality of processors that substitute for the processor 11. Execution of the exchange-type attack simulation program is divided among the plurality of processors. Each of the processors is an IC to execute various processes, as with the processor 11.

Information, data, signal values, and variable values that indicate results of processes in the input processing unit 21, the e-mail reception unit 22, the e-mail learning unit 23, the state transition unit 24, the e-mail generation unit 25, and the e-mail transmission unit 26 are stored in the memory 12, the auxiliary storage device 13, or a register or a cache memory in the processor 11.

The exchange-type attack simulation program may be stored in a portable storage medium such as a magnetic disc and an optical disc.

*** Description of Operation ***

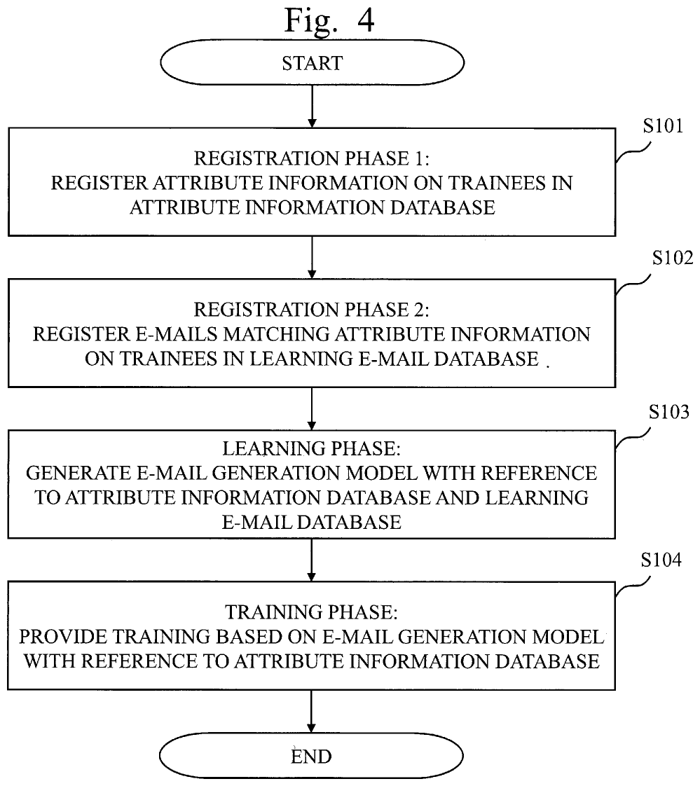

With reference to FIGS. 4 to 14, as well as FIGS. 1 to 3, operation of the exchange-type attack simulation device 10 in accordance with the embodiment will be described. The operation of the exchange-type attack simulation device 10 corresponds to an exchange-type attack simulation method in accordance with the embodiment.

As illustrated in FIG. 4, a processing procedure of the exchange-type attack simulation device 10 may be broadly divided into three phases, which are a registration phase of step S101 and step S102, a learning phase of step S103, and a training phase of step S104.

In step S101, the exchange-type attack simulation device 10 makes the instructor sort out the trainees and registers the attribute information 32 on the trainees in the attribute information database 41. The attribute information 32 is information such as names, organizations, and e-mail addresses of the trainees that are to be used for generation of e-mails. That is, the attribute information 32 is information indicating attributes of the trainees.

In step S102, the exchange-type attack simulation device 10 collects e-mails matching the registered attribute information 32 on the trainees and registers the e-mails in the learning e-mail database 43. This step may be omitted on condition that e-mails have already been registered in the learning e-mail database 43.

In step S103, the exchange-type attack simulation device 10 generates an e-mail generation model based on the attribute information database 41 and the learning e-mail database 43.

In step S104, the exchange-type attack simulation device 10 provides a training for the trainees based on the e-mail generation model generated in the learning phase and the attribute information 32 registered in the attribute information database 41 in the registration phase.

Details of the operation in each of the phases will be described.

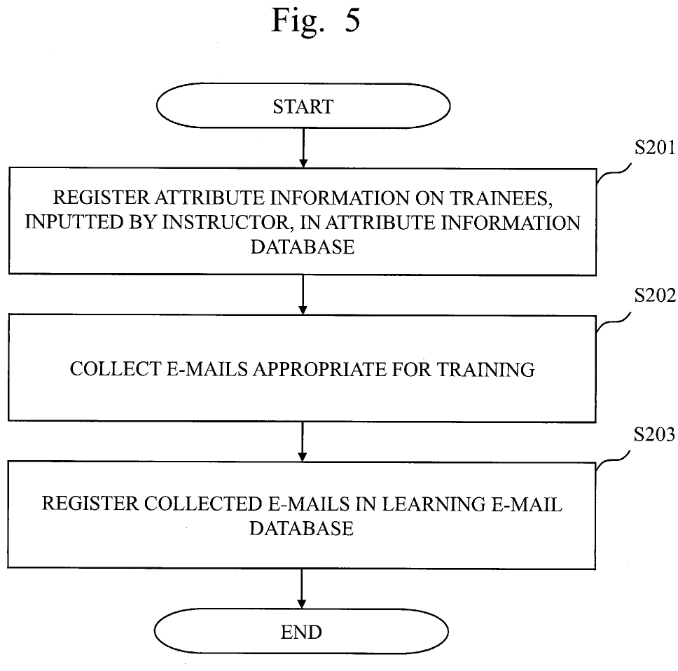

With reference to FIGS. 2 and 5, principally, description on the registration phase will be given.

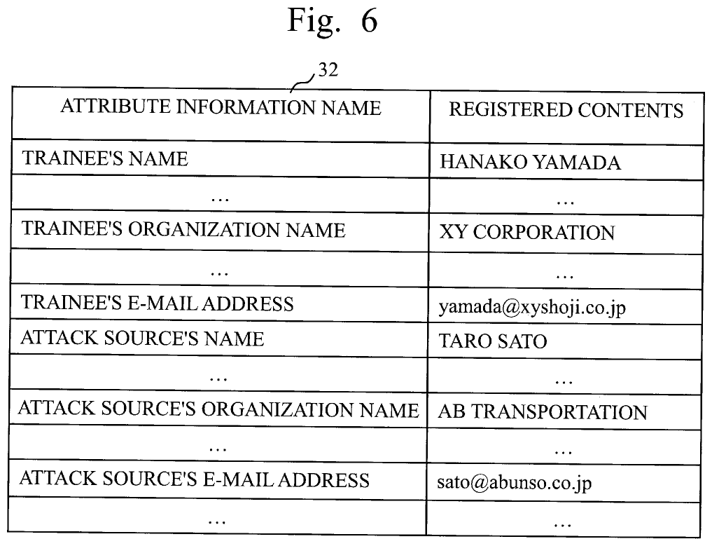

In step S201, the input processing unit 21 receives input of the attribute information 32 on the sorted trainees from the instructor. The input processing unit 21 registers the attribute information 32 on the trainees, inputted by the instructor, in the attribute information database 41. An example of the attribute information 32 registered in the attribute information database 41 is illustrated in FIG. 6. In this example, a name, a name of a belonging organization, and an e-mail address of a trainee and a name, a name of an organization, and an e-mail address of an attack source that is to be a source of a targeted attack in the training are specified. Information such as a business outline and hobbies of the trainee may be additionally inputted. Tags of attribute information names may be appropriately added as long as the names are similar to tags used in the e-mail generation model.

In step S202, the input processing unit 21 collects a set of e-mails appropriate as e-mails on which the training for the trainees is based, from the organizations of the trainees or the like, based on the attribute information 32 registered in the attribute information database 41 in step S201. In case where a trainee is a person at a contact point for queries who replies to questions from outside or the like, e-mails as replies from persons at the contact point for queries to the questions from the outside are collected as an example of the e-mails on which the training is based. These e-mails may be collected through a request for cooperation to the organization of the trainee. Collection of the e-mails by the instructor may be carried out, instead of automatic collection of the e-mails by the input processing unit 21, and the input processing unit 21 may receive input of the collected e-mails from the instructor.

In step S203, the input processing unit 21 registers the e-mails, collected in step S202, in the learning e-mail database 43. Processes of step S202 and step S203 may be omitted on condition that e-mails sufficient to be learning data have already been registered in the learning e-mail database 43.

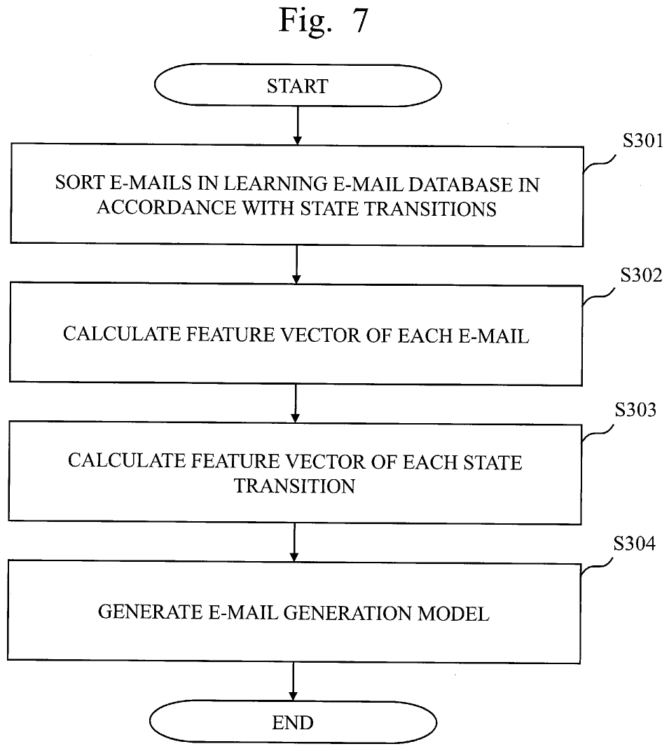

With reference to FIGS. 3 and 7, principally, description on the learning phase will be given.

The learning phase is started based on an instruction from the input processing unit 21, when the input processing unit 21 receives an instruction for a start of learning from the instructor after an end of the registration phase. In the learning phase, the e-mail learning unit 23 analyzes the e-mails to be subjected to the learning, sorts the e-mails into each of the state transitions, and extracts a feature vector from the e-mails. The e-mail learning unit 23 calculates the feature vector of each of the state transitions and generates the e-mail generation model based on the e-mails sorted in accordance with the state transitions.

In step S301, the e-mail sorting unit 51 sorts the e-mails in the learning e-mail database 43, in accordance with the state transitions such as reconnaissance, attack, and reminder. As described above, the reconnaissance may be identified with the query and the attack may be identified with the file attachment or the reference to a URL in a body.

In an example of a method of sorting, the e-mail sorting unit 51 initially divides the e-mails in the learning e-mail database 43 in accordance with each exchange. Specifically, the e-mail sorting unit 51 divides the e-mails into each series of exchanges having an e-mail as a starting point and having an e-mail subsequent to several exchanges as an end point.

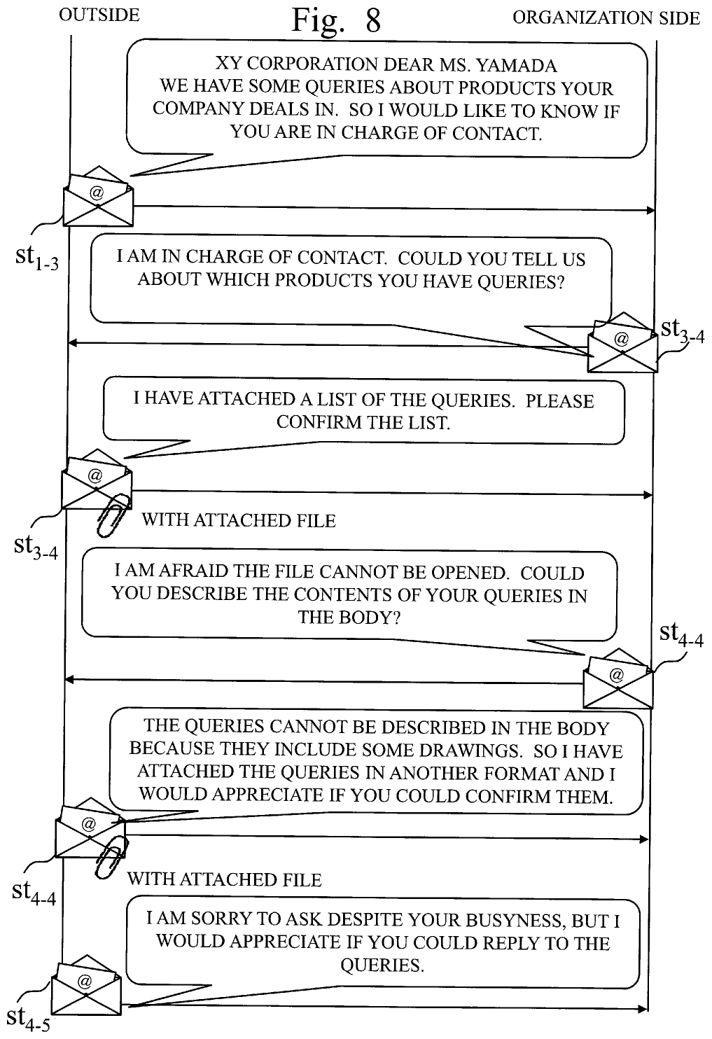

After dividing the e-mails into each series of exchanges, the e-mail sorting unit 51 sorts the e-mail of each exchange into each of the state transitions. FIG. 8 illustrates an example in which e-mails of a series of exchanges are sorted into each of the state transitions. As a rule of the sorting, an e-mail transmitted from the outside, not an e-mail from the organization of the trainee, is made the starting point. Ordinarily, a query begins at the outside. Therefore, the e-mail sorting unit 51 sorts the e-mails by treating a transmitter at which a series of exchanges begins, as the outside, and treating a side to respond to the query, as a side of the organization.

Initially, the e-mail sorting unit 51 assigns one of the states in the state transition model illustrated in FIG. 1, to each of the states of the exchanges. A state before the start of the exchanges is the state s1 of start. A state in which the exchanges have ended is the state s2 of end. A state in which an e-mail having no attached file and no URL in the body has been received on the side of the organization is the state s3 of reconnaissance. A state in which an e-mail having an attached file or a URL in the body has been received on the side of the organization is the state s4 of attack. A state in which e-mails are successively transmitted from the side of the organization is the state s5 of reminder. Thus the e-mail sorting unit 51 assigns the states to all the exchanges of e-mails.

Subsequently, the e-mail sorting unit 51 respectively assigns the state transitions to both of the e-mails transmitted from the outside and the e-mails transmitted from the side of the organization, in accordance with how the state of the exchange makes the transition.

The method of sorting the e-mails that is disclosed herein is an example and another method may be used.

In step S302, the first vector calculation unit 52 extracts a feature included in each of the e-mails. Specifically, the first vector calculation unit 52 calculates a feature vector of each e-mail.

An example of a method of extracting the feature vector from an e-mail is a technique referred to as mail2vec and disclosed in https://devpost.com/software/mail2vec. In this technique, an e-mail is converted into a feature vector based on word2vec and a dataset learned in advance. In another example, an e-mail may be converted into a feature amount with use of paragraph vector technology such as sentence2vec or doc2vec.

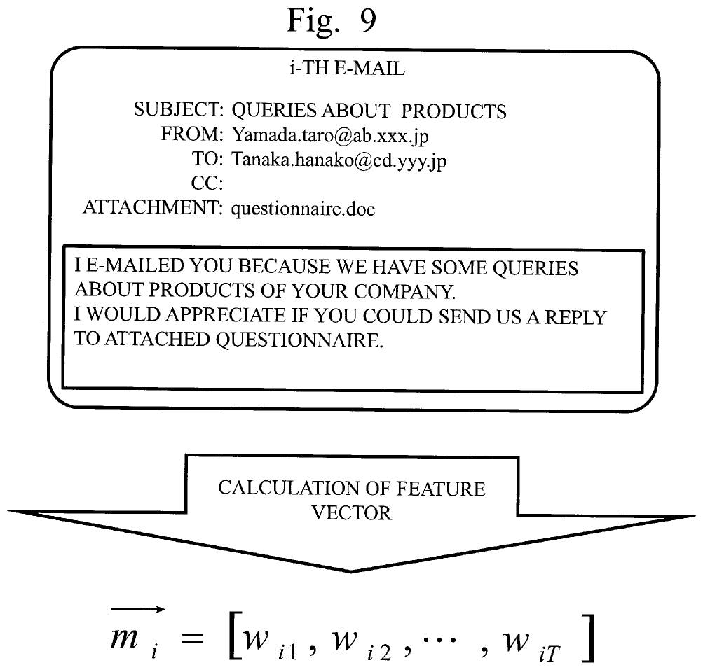

Through these techniques of conversion into feature amount, an e-mail is converted into a T-dimensional vector, as illustrated in FIG. 9.

A feature vector calculation method disclosed herein is an example and another method may be used.

In step S303, the second vector calculation unit 53 calculates a feature vector of each of the state transitions, based on the feature vectors of the e-mails sorted for each of the state transitions. The second vector calculation unit 53 saves the correspondence information 31 indicating the feature vector of each of the state transition, in the memory 12.

As an example of the method of calculating the feature vector of a state transition into which a plurality of e-mails are sorted, the second vector calculation unit 53 may calculate an average of feature vectors of the plurality of e-mails as the feature vector of the state transition. Specifically, the second vector calculation unit 53 calculates the feature vector of a state transition, by the following expression.

$$\vec{{st}_{p - q}} = \frac{1}{\vert \sum \vec{{m}_{i}} \vert} \sum \vec{{m}_{i}} \qquad FORMULA 1$$

\vec{mᵢ} Feature vector of i-th e-mail corresponding to a state transition (0≤i<L) i is an integer and L is a number of elements included in a set of e-mails \vec{st_{p-q}} Feature vector of state transition st_{p-q} from state sₚ to state s_{q}

The feature vector calculation method for the state transition that is disclosed herein is an example and another method may be used.

In step S301 to step S303, as described above, the e-mail learning unit 23 analyzes the e-mails mapped to each of the state transitions of the state transition model, among actually exchanged e-mails, and extracts the feature of the e-mails corresponding to each of the state transitions. The e-mail learning unit 23 writes information indicating the extracted features as the correspondence information 31 into the memory 12.

Specifically, the e-mail learning unit 23 maps the actually exchanged e-mails to each of the state transitions in accordance with at least any of sources, destinations, contents of the bodies, and presence or absence of attached files. The e-mail learning unit 23 calculates the average of the feature vectors of the e-mails mapped to each of the state transitions, as the feature vector of each of the state transitions. The e-mail learning unit 23 writes the feature vector of each of the state transitions, as the correspondence information 31, into the memory 12.

In step S304, the model generation unit 54 generates the e-mail generation model that is data to be a template for generation of a text of an e-mail in the training phase. The model generation unit 54 registers the generated e-mail generation model in the e-mail generation model database 42.

In an example of a technique of deriving the e-mail generation model, the model generation unit 54 generates the e-mail generation model expressed by a Markov model as follows. Though the model generated in the example supports Japanese language, the model may be made to support a diversity of languages by change in the deriving technique.

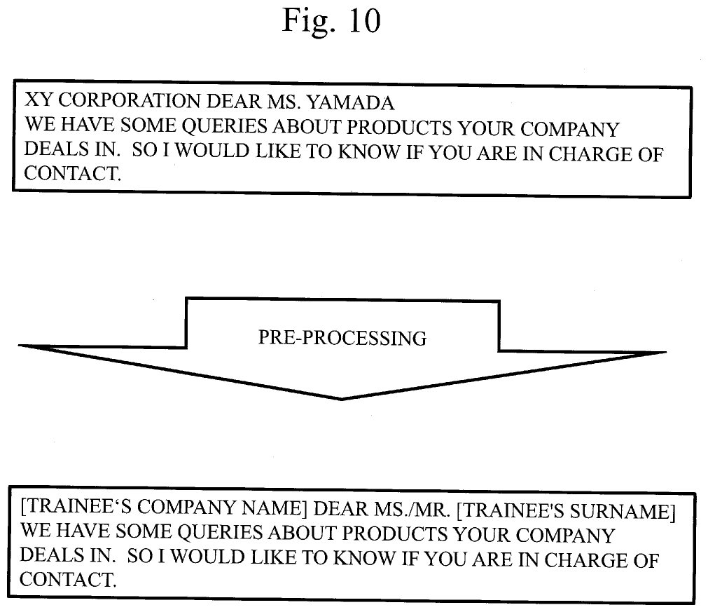

The model generation unit 54 initially heightens a level of abstraction of the learning data by execution of such pre-processing as illustrated in FIG. 10. That is, the model generation unit 54 replaces a name of a company and a surname of a recipient of an e-mail with symbols of the same names as the tags of the attribute information 32, such as [TRAINEE'S COMPANY NAME] and [TRAINEE'S SURNAME]. Specifically, the model generation unit 54 makes a morphological analysis with use of such an existing technique as MeCab and identifies which symbol with which a subject is to be replaced, by reference to organization names and personal names of nouns. A determination as to whether the subject to be replaced is the trainee or the attack source may be made with use of a source address or based on a determination on presence or absence of a title.

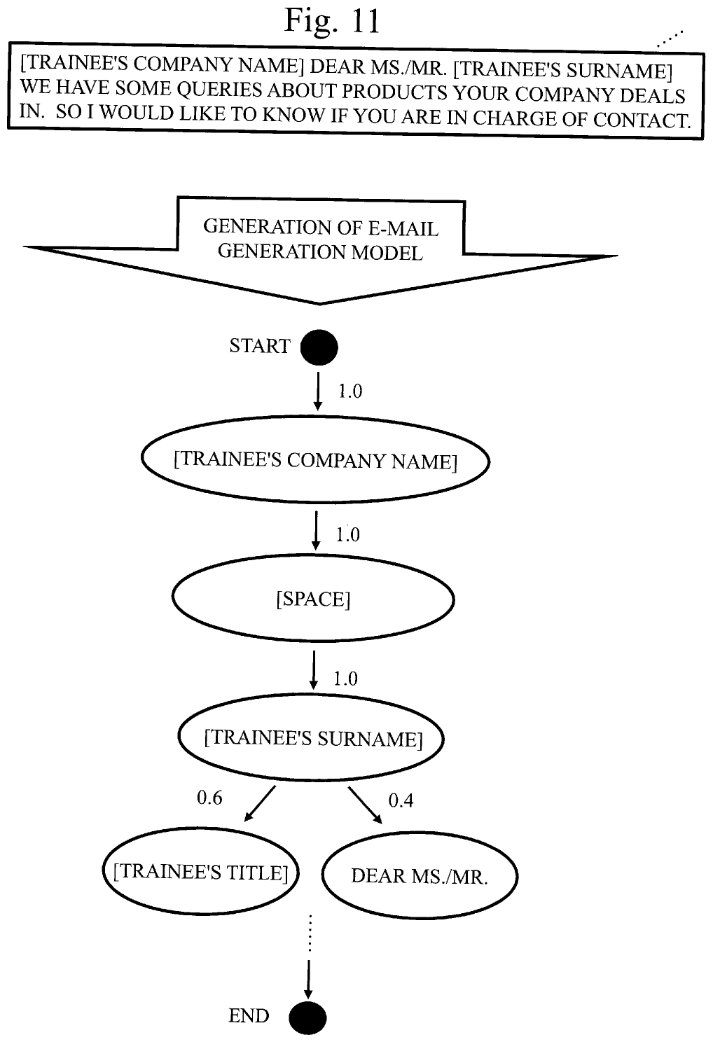

Subsequently, the model generation unit 54 makes a morphological analysis of a preprocessed text with use of the text as input and thereby generates such a Markov model as illustrated in FIG. 11. Though the Markov model is generated for each word in the example, the Markov model may be generated in units of sentences or the like, other than words.

The e-mail generation model and an automatic text generation technique that are disclosed herein is an example and another method may be used.

With reference to FIGS. 2, 12, and 13, principally, description of the training phase will be given.

The training phase is started based on an instruction from the input processing unit 21, when the input processing unit 21 receives an instruction for a start of a training from the instructor after an end of the learning phase.

In step S401, the e-mail generation unit 25 generates an e-mail to be transmitted as a first e-mail. The e-mail transmission unit 26 transmits the e-mail. The first e-mail is an e-mail of the state transition to either of the state of reconnaissance or the state of attack. Though the state of a transition destination is selected by the e-mail generation unit 25 based on a probability of transition from the state of start to the state of reconnaissance or the state of attack, the state of the transition destination may be selected by the instructor.

Specifically, the e-mail generation unit 25 initially generates a text of the e-mail, based on the e-mail generation model registered in the e-mail generation model database 42 in the learning phase and based on the attribute information database 41.

The e-mail generation model to be used by the e-mail generation unit 25 is selected based on specification of a state transition from the outside. Subsequently, the e-mail generation unit 25 adds a header portion such as a destination and a source and an attached file, if required, to the e-mail and thereby produces the e-mail in a transmittable state. That is, the e-mail generation unit 25 selects the e-mail generation model to be used from among the e-mail generation models generated by the e-mail learning unit 23, based on the state transition, and generates the e-mail based on the model and the attribute information database 41. The e-mail transmission unit 26 transmits the e-mail in the transmittable state, generated by the e-mail generation unit 25, to a trainee that is a destination.

Details of the generation of the e-mail will be described.

The e-mail generation unit 25 selects a model of the e-mail to be generated, from the e-mail generation model database 42, based on the state transition derived from a previous state and a current state. The e-mail generation unit 25 generates the text of the e-mail, with reference to the selected model and the attribute information database 41. In case where the current state is of attack, the e-mail generation unit 25 attaches an attached file to the e-mail or describes a URL in the body of the e-mail. A determination as to whether to attach the attached file to the e-mail or to describe the URL in the body of the e-mail is made based on whether the generated text includes any word related to the attached file or any word related to the URL. The attached file is a file that may be found to be intended for a training by the trainee having opened the file, such as a document in which an intention of the training is described. The URL is a URL that may be found to be intended for a training by the trainees having referred to the URL, such as the URL of a site in which an intention of the training is described.

In step S402, the e-mail reception unit 22 waits for an e-mail from the trainee.

If the e-mail reception unit 22 has received the e-mail or if a specified period of time has elapsed, in step S403, a state transition process of step S404 is executed. If not, a waiting state of step S402 is continued.

When receiving the e-mail, the e-mail reception unit 22 delivers the e-mail to the state transition unit 24. In case where no e-mail has been sent to the e-mail reception unit 22 though the specified period of time has elapsed, the e-mail reception unit 22 sends the state transition unit 24 notification that no e-mail has been sent.

In step S404, the state transition unit 24 receives the e-mail received by the e-mail reception unit 22 or the notification that the specified period of time has elapsed without reception of any e-mail, from the e-mail reception unit 22. The state transition unit 24 saves the current state as the previous state and makes a transition of the state.

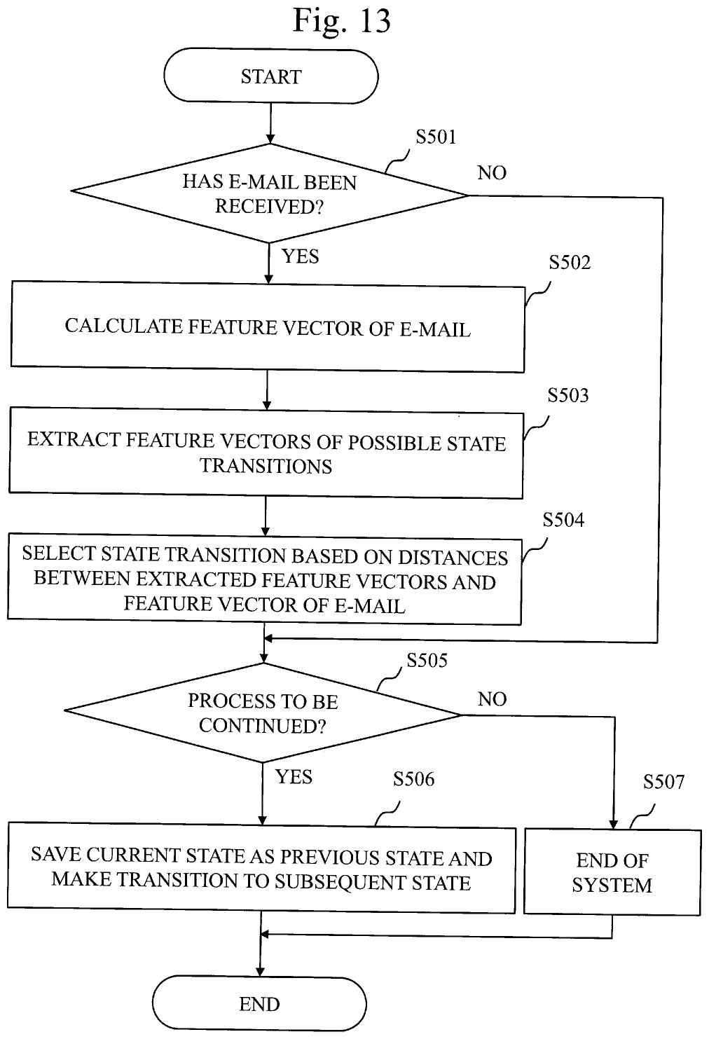

A procedure of the state transition process of step S404 is illustrated in FIG. 13.

In step S501, the state transition unit 24 determines whether any e-mail has been received or not. If received, a process of step S502 is executed. If not received, a process of step S505 is executed.

In step S502, the state transition unit 24 calculates a feature vector of the received e-mail. As a feature vector calculation method, the method described above may be used.

In step S503, the state transition unit 24 selects candidates to be selected as a state transition, based on states that may be the subsequent transition destination from the current state, and extracts feature vectors of the state transitions. An extraction source of the feature vectors is the correspondence information 31 saved in the memory 12 in step S303.

In step S504, the state transition unit 24 calculates distances between the feature vectors extracted in step S503 and the feature vector of the e-mail calculated in step S502. The state transition unit 24 selects the state transition, based on a calculation result.

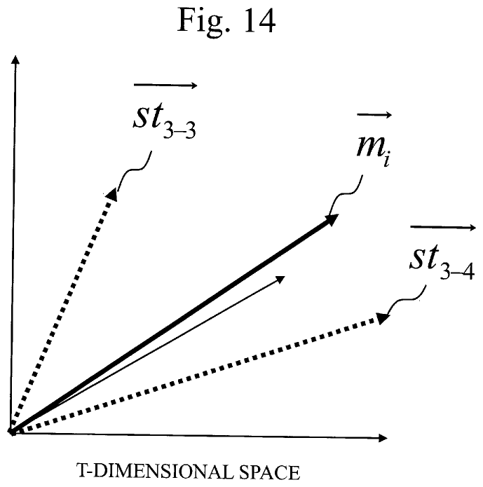

In FIG. 14, examples of the feature vector of the e-mail and the feature vectors of the state transitions are illustrated. In FIG. 14, the feature vector of an e-mail mᵢ calculated on condition that the current state is the state s3 of reconnaissance, the feature vector of the state transition st₃₋₃ through which a transition from the state s3 of reconnaissance to the state s3 of reconnaissance is made, and the feature vector of the state transition st₃₋₄ through which a transition from the state s3 of reconnaissance to the state s4 of attack is made are illustrated in a T-dimensional space. Each of the feature vectors is a T-dimensional vector.

The state transition st₃₋₄ through which the transition from the state s3 to the state s4 is made is selected in case where the following two expressions in which a threshold of the distances is designated by δ are satisfied at the same time.

FORMULA 2

|\vec{mᵢ}−\vec{st₃₋₄}≤δ (1)

|\vec{mᵢ}−\vec{st₃₋₄}≤|\vec{mᵢ}−\vec{st₃₋₃}| (2)

In case where a condition that an e-mail for notification of opening of the attached file has been sent from the trainee or the like is satisfied, the state transition unit 24 selects a state transition through which a transition to the state s2 of end is made.

A technique of selecting the state transition that is disclosed herein is an example and another method may be used.

In step S501 to step S504 as described above, when the e-mail reception unit 22 receives a reply e-mail to the e-mail transmitted by the e-mail transmission unit 26, the state transition unit 24 refers to the correspondence information 31 stored in the memory 12 and thereby identifies the state transition corresponding to the reply e-mail received by the e-mail reception unit 22.

Specifically, the state transition unit 24 extracts a feature of the reply e-mail received by the e-mail reception unit 22. The state transition unit 24 makes comparisons between the feature of the reply e-mail and the features of the e-mails corresponding to each of the state transitions. The state transition unit 24 identifies the state transition corresponding to the reply e-mail, based on results of the comparisons.

More specifically, the state transition unit 24 calculates the feature vector of the reply e-mail received by the e-mail reception unit 22. The state transition unit 24 calculates the distance between the feature vector of the reply e-mail and the feature vector of each of the state transitions. The state transition unit 24 identifies the state transition corresponding to the reply e-mail, based on the calculated distance.

The state transition unit 24 determines whether the reply to the e-mail transmitted by the e-mail transmission unit 26 has been made or not. Upon a determination that the reply has not been made, the state transition unit 24 identifies the subsequent state transition, based on the state transition corresponding to the e-mail transmitted by the e-mail transmission unit 26. In case where no reply has been made for the specified period of time in response to the e-mail with an attached file corresponding to the state transition st₄₋₄, as a specific example, the state transition unit 24 identifies the state transition st₄₋₅ as the subsequent state transition and makes the e-mail generation unit 25 generate a reminder e-mail.

If, in step S505, the transition destination of the state transition determined in step S504 is the state s2 of end, or if occurrence of an exception such as absence of the transition destination of the state transition determined in step S504, continuation of absence of the reply for the specified period of time, or the like is brought about, a process of step S507 is executed. If not, a process of step S506 is executed.

In step S506, the state transition unit 24 saves the current state as the previous state, determines the subsequent state based on the state transition selected in step S505, and updates the current state.

In step S507, the state transition unit 24 saves the current state as the previous state and changes the current state into the state s2 of end. An ending process for the system is executed in step S405.

In step S405, the state transition unit 24 checks whether the current state is the state s2 of end. If the state is of end, the processes are directly ended. If not, a process of step S406 is executed.

In step S406, the e-mail generation unit 25 generates an e-mail as with step 5401. The e-mail transmission unit 26 transmits the e-mail as with step S401. In step S406, however, the e-mail generation unit 25 selects an e-mail generation model to be used, based on the state transition derived from the previous state and the current state. The e-mail generation unit 25 generates the e-mail, with use of the selected e-mail generation model.

In step S406, as described above, the e-mail generation unit 25 generates the e-mail corresponding to the state transition identified by the state transition unit 24. The e-mail generation unit 25 makes the e-mail transmission unit 26 transmit the generated e-mail.

When generating the e-mail, the e-mail generation unit 25 adjusts contents of the e-mail to be generated, with reference to the attribute information 32 on the trainee read out from the attribute information database 41 and stored in the memory 12. The e-mail transmission unit 26 sets the e-mail address of the trainee as a destination of the e-mail to be transmitted.

*** Description of Effects of Embodiment ***

According to the embodiment, the trainee may be made to experience the threat of the exchange-type attack and may be educated, through automatic provision of the simulation of the exchange-type attack.

According to the embodiment, the training against the exchange-type attack may be automatically provided, so that the training against the sophisticated targeted e-mail attack which could not be provided conventionally may be provided easily.

*** Other Configurations ***

Though the functions of the input processing unit 21, the e-mail reception unit 22, the e-mail learning unit 23, the state transition unit 24, the e-mail generation unit 25, and the e-mail transmission unit 26 are implemented by software in the embodiment, the functions of the input processing unit 21, the e-mail reception unit 22, the e-mail learning unit 23, the state transition unit 24, the e-mail generation unit 25, and the e-mail transmission unit 26 may be implemented by a combination of software and hardware in a modification. That is, a portion of the functions of the input processing unit 21, the e-mail reception unit 22, the e-mail learning unit 23, the state transition unit 24, the e-mail generation unit 25, and the e-mail transmission unit 26 may be implemented by dedicated electronic circuits and the remainder may be implemented by the software.

The dedicated electronic circuits are single circuits, composite circuits, programmed processors, parallelly programmed processors, logic ICs, GAs, FPGAs, or ASICs, for instance. The term “GA” is an abbreviation for Gate Array. The term “FPGA” is an abbreviation for Field-Programmable Gate Array. The term “ASIC” is an abbreviation for Application Specific Integrated Circuit.

The processor 11, the memory 12, and the dedicated electronic circuits are collectively referred to as “processing circuitry”. That is, the functions of the input processing unit 21, the e-mail reception unit 22, the e-mail learning unit 23, the state transition unit 24, the e-mail generation unit 25, and the e-mail transmission unit 26 are implemented by the processing circuitry, irrespective of whether the functions of the input processing unit 21, the e-mail reception unit 22, the e-mail learning unit 23, the state transition unit 24, the e-mail generation unit 25, and the e-mail transmission unit 26 are implemented by software or are implemented by a combination of software and hardware.

The “device” of the exchange-type attack simulation device 10 may be read as “method” and the “unit” of the input processing unit 21, the e-mail reception unit 22, the e-mail learning unit 23, the state transition unit 24, the e-mail generation unit 25, and the e-mail transmission unit 26 may be read as “step”. Alternatively, the “device” of the exchange-type attack simulation device 10 may be read as “program”, “program product”, or “computer-readable medium having a program recorded therein” and the “unit” of the input processing unit 21, the e-mail reception unit 22, the e-mail learning unit 23, the state transition unit 24, the e-mail generation unit 25, and the e-mail transmission unit 26 may be read as “procedure” or “process”.

Embodiment 2.

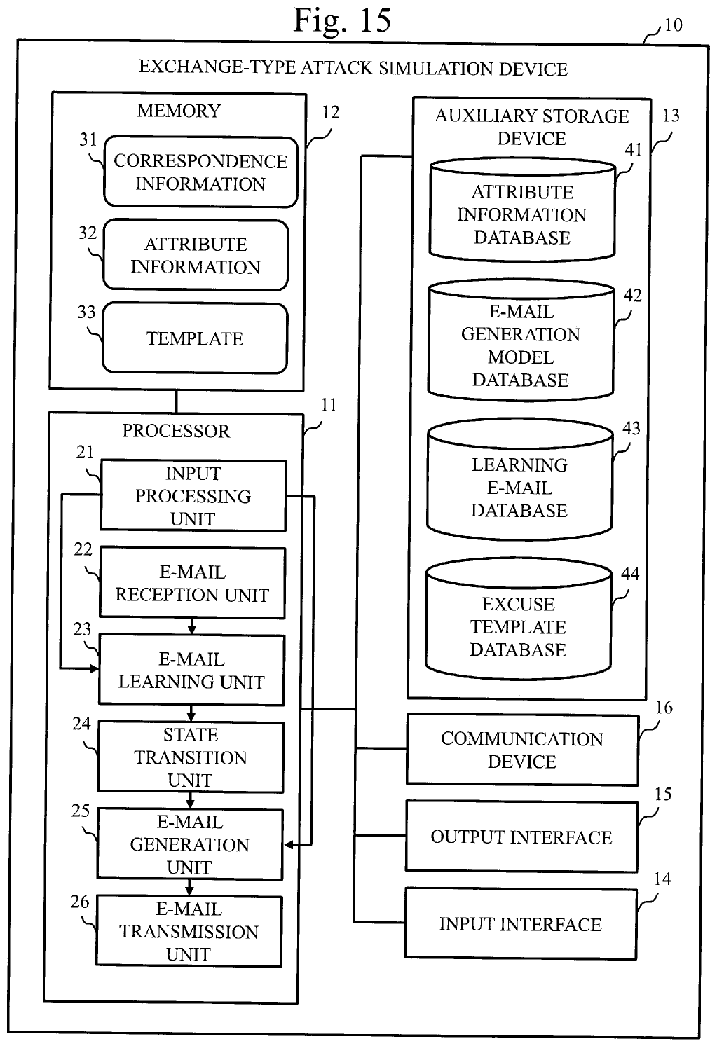

As for the present embodiment, differences from Embodiment 1 will be principally described with use of FIGS. 15 to 17.

*** Description of Configuration ***

With reference to FIG. 15, a configuration of the exchange-type attack simulation device 10 in accordance with the embodiment will be described.

A template 33 of excuse, as well as the correspondence information 31 and the attribute information 32, is stored in the memory 12.

In the auxiliary storage device 13, an excuse template database 44, as well as the attribute information database 41, the e-mail generation model database 42, and the learning e-mail database 43, is constructed.

*** Description of Operation ***

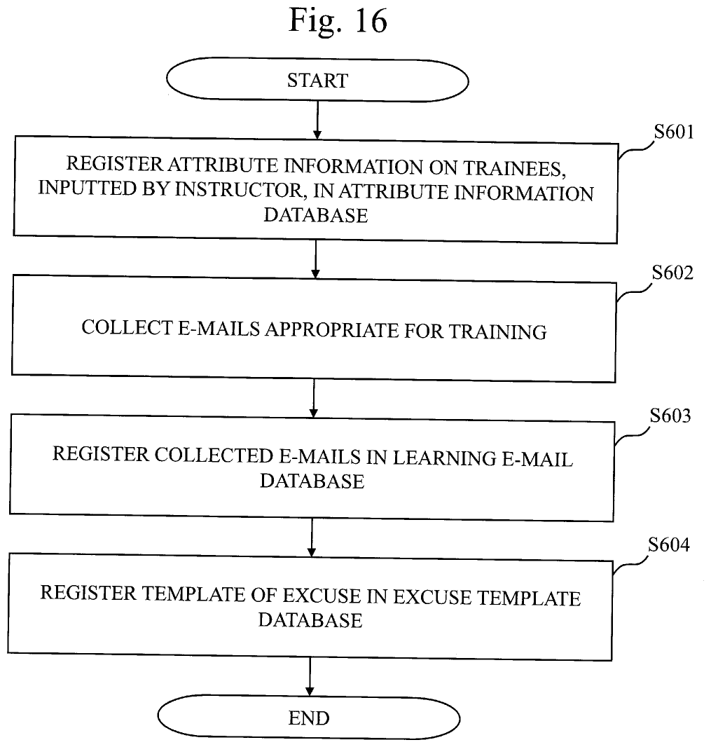

With reference to FIG. 16, as well as FIG. 15, operation of the exchange-type attack simulation device 10 in accordance with the embodiment will be described. The operation of the exchange-type attack simulation device 10 corresponds to an exchange-type attack simulation method in accordance with the embodiment.

In the e-mails that are registered in the learning e-mail database 43, normal exchanges are recorded. Therefore, “excuses” that are seen in the exchange-type attacks and that obstinately push for opening of attached files are not ordinarily made therein. In Embodiment 1, accordingly, it is difficult to reproduce an attack that obstinately pushes for the opening of the attached file many times.

In the embodiment, such an obstinate e-mail attack is reproduced with preparation of the template 33 of excuse for situations that require excuses.

The embodiment differs from Embodiment 1 in the registration phase and the training phase.

With reference to FIGS. 15 and 16, principally, description of the registration phase will be given.

Step S601 to step S603 are the same as step S201 to step S203 illustrated in FIG. 5.

In step S604, the input processing unit 21 receives input of the template 33 of excuse from the instructor. The input processing unit 21 registers the template 33 of excuse, inputted by the instructor, in the excuse template database 44.

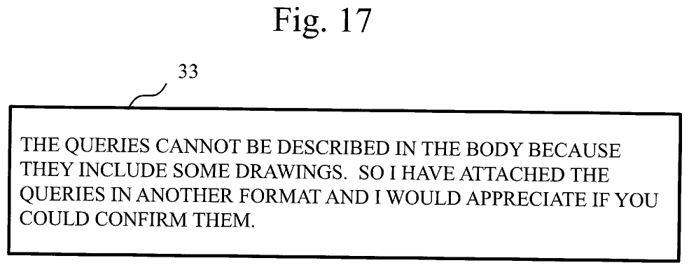

In FIG. 17, an example of the template 33 of excuse is illustrated. As in this example, the template 33 of excuse is used as a text of an e-mail.

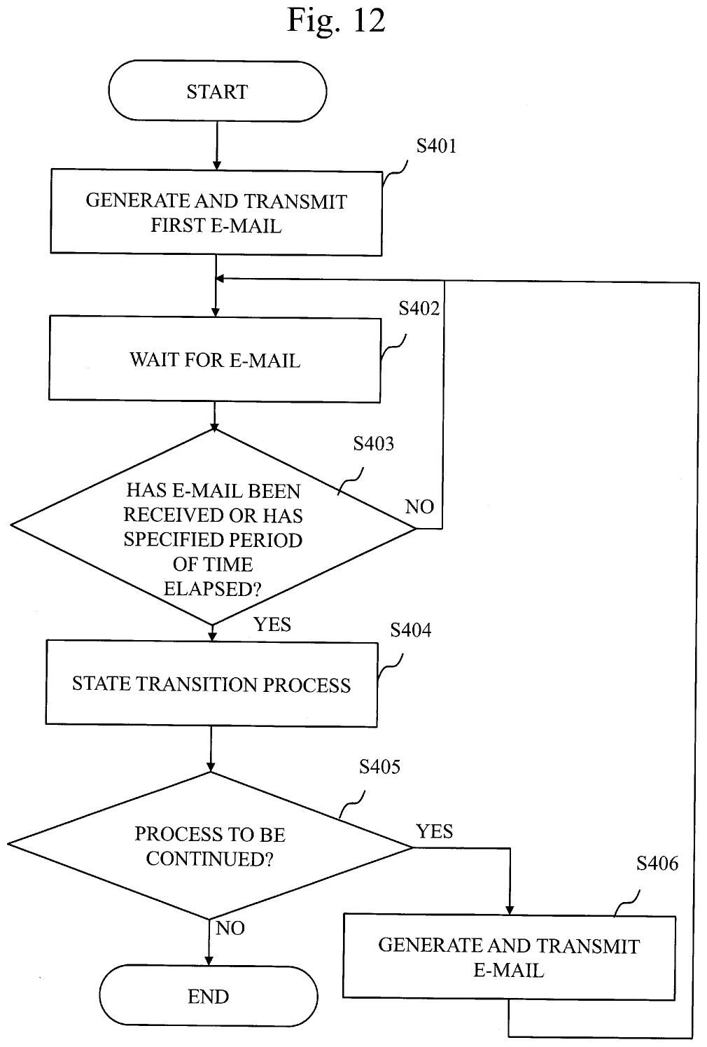

Flow of the processes of the training phase is the same as that of Embodiment 1 but has a difference in the process of generation of the e-mail in step S406 illustrated in FIG. 12.

In step S406, in case where the state transition identified by the state transition unit 24 in step S404 is the state transition st₄₋₄, the e-mail generation unit 25 determines that an excuse needs to be given to the trainee. Then the e-mail generation unit 25 refers to the excuse template database 44, instead of referring to the e-mail generation model database 42, and produces a body of the e-mail by applying the attribute information 32 in the attribute information database 41.

In step S406, as described above, the e-mail generation unit 25 determines necessity of an excuse to be included in the body of the e-mail to be generated, in accordance with the state transition identified by the state transition unit 24. Upon a determination that the excuse is necessary, the e-mail generation unit 25 adjusts contents of the e-mail to be generated, with use of the template 33 read out from the excuse template database 44 and stored in the memory 12. In case where the state transition identified in step S404 is the state transition st₄₋₄, as a specific example, the e-mail generation unit 25 produces a text of an attack e-mail from the template 33 of excuse without modification or with appropriate editing.

*** Description of Effects of Embodiment ***

According to the embodiment, the obstinate e-mail attack may be reproduced, so that the training against the sophisticated targeted e-mail attack which could not be provided conventionally may be provided easily.

Embodiment 3.

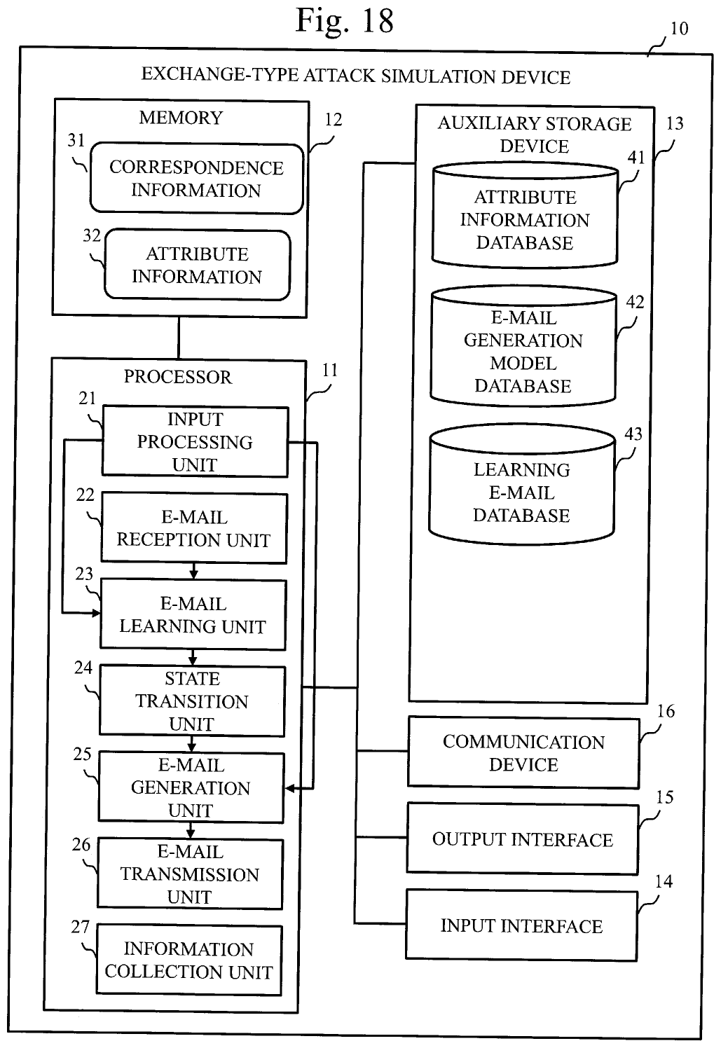

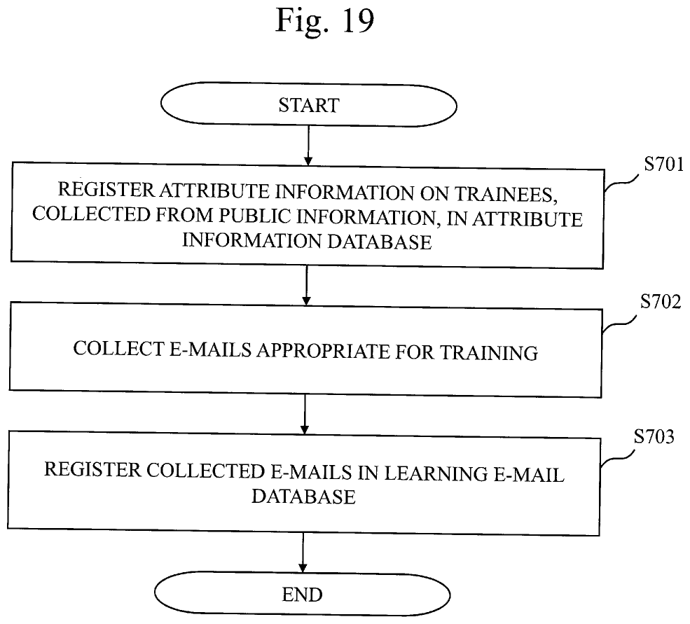

As for the present embodiment, differences from Embodiment 1 will be principally described with use of FIGS. 18 and 19.

*** Description of Configuration ***

With reference to FIG. 18, a configuration of the exchange-type attack simulation device 10 in accordance with the embodiment will be described.

The exchange-type attack simulation device 10 includes an information collection unit 27, as well as the input processing unit 21, the e-mail reception unit 22, the e-mail learning unit 23, the state transition unit 24, the e-mail generation unit 25, and the e-mail transmission unit 26, as functional components. Functions of the input processing unit 21, the e-mail reception unit 22, the e-mail learning unit 23, the state transition unit 24, the e-mail generation unit 25, the e-mail transmission unit 26, and the information collection unit 27 are implemented by software.

*** Description of Operation ***

With reference to FIG. 19, as well as FIG. 18, operation of the exchange-type attack simulation device 10 in accordance with the embodiment will be described. The operation of the exchange-type attack simulation device 10 corresponds to an exchange-type attack simulation method in accordance with the embodiment.

In Embodiment 1, the attribute information 32 to be registered in the attribute information database 41 needs to be manually inputted by the instructor. Such manual input, however, may become extremely troublesome when there are a large number of trainees or when the attribute information 32 on the trainees cannot be directly obtained and needs to be collected from public information.

In the embodiment, trouble of the manual input of the attribute information 32 by the instructor may be saved by addition of a function of automatically collecting the attribute information 32 sufficient for the training, from fragmented information such as the names of the trainees or the names of the companies.

The embodiment differs from Embodiment 1 in the registration phase.

With reference to FIGS. 18 and 19, principally, description of the registration phase will be given.

In step S701, the information collection unit 27 collects the attribute information 32 on the trainees from the public information and registers the attribute information 32 in the attribute information database 41. Collection of the information is implemented by use of an existing technique broadly known as OSINT. The term “OSINT” is an abbreviation for Open Source INTelligence.

Step S702 and step S703 are the same as step S202 and step S203 illustrated in FIG. 5.

*** Description of Effects of Embodiment ***

According to the embodiment, the collection of the information required for the training against the exchange-type attack may be automatically carried out, so that the training against the sophisticated targeted e-mail attack which could not be provided conventionally may be provided easily.

*** Other Configurations ***

Though the functions of the input processing unit 21, the e-mail reception unit 22, the e-mail learning unit 23, the state transition unit 24, the e-mail generation unit 25, the e-mail transmission unit 26, and the information collection unit 27 are implemented by software in the embodiment as with Embodiment 1, the functions of the input processing unit 21, the e-mail reception unit 22, the e-mail learning unit 23, the state transition unit 24, the e-mail generation unit 25, the e-mail transmission unit 26, and the information collection unit 27 may be implemented by a combination of software and hardware, as with the modification of Embodiment 1.

Embodiment 4.

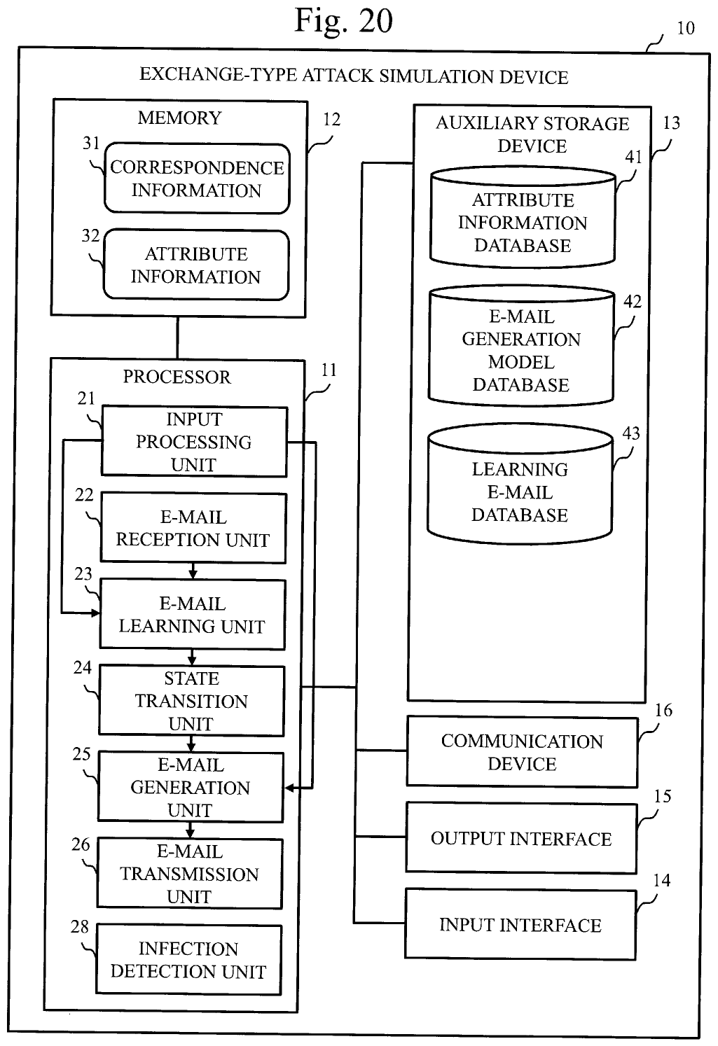

As for the present embodiment, differences from Embodiment 1 will be principally described with use of FIG. 20.

*** Description of Configuration ***

With reference to FIG. 20, a configuration of the exchange-type attack simulation device 10 in accordance with the embodiment will be described.

The exchange-type attack simulation device 10 includes an infection detection unit 28, as well as the input processing unit 21, the e-mail reception unit 22, the e-mail learning unit 23, the state transition unit 24, the e-mail generation unit 25, and the e-mail transmission unit 26, as functional components. Functions of the input processing unit 21, the e-mail reception unit 22, the e-mail learning unit 23, the state transition unit 24, the e-mail generation unit 25, the e-mail transmission unit 26, and the infection detection unit 28 are implemented by software.

*** Description of Operation ***

With reference to FIG. 20, operation of the exchange-type attack simulation device 10 in accordance with the embodiment will be described. The operation of the exchange-type attack simulation device 10 corresponds to an exchange-type attack simulation method in accordance with the embodiment.

The embodiment differs from Embodiment 1 in the training phase.

In the embodiment, flow of the processes of the training phase is the same as that of Embodiment 1 but notification is transmitted to the infection detection unit 28 when a trainee opens an attached file or clicks a URL in the body of an e-mail at an arbitrary time point during a training. That is, the infection detection unit 28 receives the notification when the attached file or a link in the e-mail transmitted by the e-mail transmission unit 26 is opened at the destination. As a result, information as to who conducted infection behavior and when the infection behavior was conducted may be collected.

Through the information collected by the infection detection unit 28, the instructor may collect information as to who among the trainees caused infection, when the infection was caused, and what exchange of e-mails resulted in the infection and may utilize the information for education of the trainees.

*** Description of Effects of Embodiment ***

According to the embodiment, the instructor is enabled to measure effects of a training. Additionally, results of such measurement may be utilized for subsequent education, so that the training against the sophisticated targeted e-mail attack which could not be provided conventionally may be provided easily.

*** Other Configurations ***

Though the functions of the input processing unit 21, the e-mail reception unit 22, the e-mail learning unit 23, the state transition unit 24, the e-mail generation unit 25, the e-mail transmission unit 26, and the infection detection unit 28 are implemented by software in the embodiment as with Embodiment 1, the functions of the input processing unit 21, the e-mail reception unit 22, the e-mail learning unit 23, the state transition unit 24, the e-mail generation unit 25, the e-mail transmission unit 26, and the infection detection unit 28 may be implemented by a combination of software and hardware, as with the modification of Embodiment 1.

### REFERENCE SIGNS LIST

10: exchange-type attack simulation device; 11: processor; 12: memory; 13: auxiliary storage device; 14: input interface; 15: output interface; 16: communication device; 21: input processing unit; 22: e-mail reception unit; 23: e-mail learning unit; 24: state transition unit; 25: e-mail generation unit; 26: e-mail transmission unit; 27: information collection unit; 28: infection detection unit; 31: correspondence information; 32: attribute information; 33: template; 41: attribute information database; 42: e-mail generation model database; 43: learning e-mail database; 44: excuse template database; 51: e-mail sorting unit; 52: first vector calculation unit; 53: second vector calculation unit; 54: model generation unit

1. An exchange-type attack simulation device to simulate an attack that is launched through exchange of e-mails, with use of a state transition model, the exchange-type attack simulation device comprising:
processing circuitry
to transmit an e-mail;
to receive a reply e-mail to the e-mail transmitted;
to refer to correspondence information, stored in a memory, indicating feature of e-mails corresponding to each of state transitions in the state transition model and to identify a state transition corresponding to the reply e-mail received ;
to generate an e-mail corresponding to the state transition identified and transmit the generated e-mail;
to set an e-mail address of a trainee as a destination of the e-mail to be transmitted; and
to determine necessity of an excuse to be included in a body of the e-mail to be generated, in accordance with the state transition identified, to select a template registered in a database upon a determination that the excuse is necessary, to adjust contents of the e-mail to be generated by editing contents of the template based on attribute information indicating attributes of the trainee and stored in the memory.

2. The exchange-type attack simulation device according to claim 1, wherein the processing circuitry:
analyzes e-mails mapped to each of the state transitions, among actually exchanged e-mails, extracts feature of the e-mails corresponding to each of the state transitions, and writes information indicating the extracted feature as the correspondence information into the memory, and
extracts a feature of the reply e-mail received, makes comparisons between the feature of the reply e-mail and the feature of the e-mails corresponding to each of the state transitions, and identifies a state transition corresponding to the reply e-mail, based on results of the comparisons.

3. The exchange-type attack simulation device according to claim 2, wherein the processing circuitry
calculates an average of feature vectors of the e-mails mapped to each of the state transitions, as a feature vector of each of the state transitions, and writes the feature vector of each of the state transitions, as the correspondence information, into the memory, and
calculates a feature vector of the reply e-mail received, calculates distances between the feature vector of the reply e-mail and the feature vector of each of the state transitions, and identifies the state transition corresponding to the reply e-mail, based on the calculated distances.

4. The exchange-type attack simulation device according to claim 2, wherein
the processing circuitry maps the actually exchanged e-mails to each of the state transitions in accordance with at least any of sources, destinations, contents of bodies, and presence or absence of attached file.

5. The exchange-type attack simulation device according to claim 1, wherein
the processing circuitry determines whether the reply to the e-mail transmitted has been made or not and, upon a determination that the reply has not been made, identifies a subsequent state transition, based on a state transition corresponding to the e-mail transmitted.

6-7. (canceled)

8. The exchange-type attack simulation device according to claim 1, wherein the processing circuitry:
collects the attribute information.

9. The exchange-type attack simulation device according to claim 1, wherein the processing circuitry:
receives notification when an attached file or a link in the e-mail transmitted is opened at a destination of the e-mail.

10. An exchange-type attack simulation method of simulating an attack that is launched through exchange of e-mails, with use of a state transition model, the exchange-type attack simulation method comprising:
transmitting, by an exchange-type attack simulation device, an e-mail;
transmitting, by a terminal of a trainee, a reply e-mail to the e-mail transmitted by the exchange-type attack simulation device;
receiving, by the exchange-type attack simulation device, the reply e-mail transmitted by the terminal of the trainee;
referring to, by the exchange-type attack simulation device, correspondence information, stored in a memory, indicating feature of e-mails corresponding to each of state transitions in the state transition model and identifying a state transition corresponding to the received reply e-mail;
generating, by the exchange-type attack simulation device, an e-mail corresponding to the identified state transition and transmitting the generated e-mail to the terminal of the trainee;
setting an e-mail address of a trainee as a destination of the e-mail to be transmitted; and
determining necessity of an excuse to be included in a body of the e-mail to be generated, in accordance with the state transition identified, selecting a template registered in a database upon a determination that the excuse is necessary, and adjusting contents of the e-mail to be generated by editing contents of the template based on attribute information indicating attributes of the trainee and stored in the memory.

11. A computer readable medium having an exchange-type attack simulation program to simulate an attack that is launched through exchange of e-mails, with use of a state transition model, the exchange-type attack simulation program that causes a computer to execute:
an e-mail transmission process of transmitting an e-mail;
an e-mail reception process of receiving a reply e-mail to the e-mail transmitted in the e-mail transmission process;
a state transition process of referring to correspondence information, stored in a memory, indicating feature of e-mails corresponding to each of state transitions in the state transition model and identifying a state transition corresponding to the reply e-mail received in the e-mail reception process; and
an e-mail generation process of generating an e-mail corresponding to the state transition identified in the state transition process and transmitting the generated e-mail through the e-mail transmission process, wherein
the e-mail transmission process sets an e-mail address of a trainee as a destination of the e-mail to be transmitted; and
the e-mail generation process determines necessity of an excuse to be included in a body of the e-mail to be generated, in accordance with the state transition identified, selects a template registered in a database upon a determination that the excuse is necessary, and adjusts contents of the e-mail to be generated by editing contents of the template based on attribute information indicating attributes of the trainee and stored in the memory.
